(19) United States
(12) Patent Application Publication
(10) Pub. No.: US 2009/0314561 A1
(43) Pub. Date: Dec. 24, 2009

(54) POWER SUPPLY STABILIZING APPARATUS AND VEHICLE USING THE SAME

(75) Inventor: Hiroyuki Handa, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/915,943

(22) PCT Filed: Jun. 15, 2006
(86) PCT No.: PCT/JP2006/311988

§ 371 Date: Nov. 29, 2007

(30) Foreign Application Priority Data
Jun. 22, 2005 (JP) 2005-181963

(51) Int. Cl. B60K 6/48

(52) U.S. Cl. 180/65.25; 180/65.21

(57) ABSTRACT

A power-supply stabilizer is arranged to be used in a vehicle which includes an alternator connected with an engine mechanism, a battery charged by the alternator, a starter connected with the battery, and an electrical load having a first end and a second end connected with the battery. The power-supply stabilizer includes a storage element, a first terminal coupled to the battery and connected with the first end of the electrical load, a second terminal connected between the battery and the second end of the electrical load, and a bidirectional DC/DC converter. The bidirectional DC/DC converter is coupled to the battery and connected between the first terminal and the second terminal for charging and discharging the storage element. The power-supply stabilizer is arranged to be connected in parallel with the electrical load. The power-supply stabilizer stabilizes a voltage supplied from the battery while being located far away from the battery.

### TECHNICAL FIELD

The present invention relates to a power-supply stabilizer for use in a vehicle and the vehicle including the stabilizer.

### BACKGROUND ART

In response to the demands for global environmental protection, various vehicles have been provided with an idling-stop function for temporarily stopping their engines when stopping during driving and for automatically restarting their engines when starting driving.

In such a vehicle provided with the idling-stop function, however, the voltage of a battery may significantly drop due to a large current flowing to a starter when its engine restarts after idling, consequently preventing other electrical loads energized by the battery from operating properly.

As such electrical loads including assisting devices, accessory devices, and other auxiliary devices have been demanded for improving the powered functions or increasing the performance, their consumption of electrical power from the battery is significantly increased. This causes the voltage of the battery to drop even if the vehicle does not have the idling-stop function.

Conventional methods for preventing the voltage of the battery to be supplied to the electrical loads from dropping will be explained below.

Japanese Patent Laid-Open Publication No. 2001-219798 discloses a storage element provided between the battery and the electrical load. The storage element includes a diode and a capacitor. When the voltage of the battery drops, the capacitor supplies a power to the electrical load for activating the load.

Japanese Patent Laid-Open Publication No. 2005-112250 discloses a voltage-drop protection circuit provided between the battery and the electrical load and a bypass switch for bypassing the protection circuit. The voltage drop protection circuit includes a diode and a capacitor or includes mainly a booster type DC/DC converter. The protection circuit prevents the electrical load from receiving a dropping voltage even when the voltage of the voltage drops. The bypass switch eliminates a loss produced in the voltage drop protection circuit when the voltage of the battery remains normal.

The storage element including the diode and the capacitor necessarily includes a capacitor having a large capacitance enough to supply a power to the electrical load when the voltage of the battery drops upon the restarting of the engine after the idling-stop operation. The capacitor may often employ an electric double layer capacitor. The electric double layer capacitor, however, has a low electric strength, such as 2.5 V although having a large capacitance. Hence, six to seven of the capacitors are connected in series in order to increase the electric strength to the voltage of about 14 V of the battery. The capacitors connected in series provide cause their total capacitance to decrease and increase their total equivalent series resistance. This arrangement requires a large capacitance to each capacitor, accordingly increasing the size and the weight of each capacitor. The voltage is maintained with the power supplied from the capacitors, and may vary due to the discharging of a current to the electrical load. If the electric double layer capacitors are connected directly with the battery, the capacitors cause a short-circuit current flowing from the battery to the capacitors at the initial state of the connection, hence requiring to avoid it.

The booster type DC/DC converter starts operating when the voltage of battery is drops. This causes the battery to output a large current for driving the booster type DC/DC converter as well as a large current for activating the starter. This causes the voltage of the battery to drop as the load increases. In the case that the booster type DC/DC converter is located far away from the battery, the resistance of a harness wire connecting between the DC/DC converter and the battery causes the voltage to drop. This voltage drop may affect the operation and efficiency of the booster type DC/DC converter, hence requiring to locate the DC/DC converter near the battery. The conventional protection circuit including the booster type DC/DC converter is connected in series with a power supply line extending from the battery to the electrical load, and serves as a resistor for causing the voltage to drop when the voltage of the battery remains normal. Hence, the protection circuit requires the bypass circuit, such as a relay or a switch, for bypassing the protection circuit when the voltage of the battery is normal.

### SUMMARY OF THE INVENTION

A power-supply stabilizer is arranged to be used in a vehicle which includes an alternator connected with an engine mechanism, a battery charged by the alternator, a starter connected with the battery, and an electrical load having a first end and a second end connected with the battery. The power-supply stabilizer includes a storage element, a first terminal coupled to the battery and connected with the first end of the electrical load, a second terminal connected between the battery and the second end of the electrical load, and a bidirectional DC/DC converter. The bidirectional DC/DC converter is coupled to the battery and connected between the first terminal and the second terminal for charging and discharging the storage element. The power-supply stabilizer is arranged to be connected in parallel with the electrical load.

The power-supply stabilizer stabilizes a voltage supplied from the battery while being located far away from the battery.

### BRIEF DESCRIPTION OF THE DRAWINGS

FIG. 1 is a block circuit diagram of a power supply for a vehicle according to an exemplary embodiment of the present invention.

FIG. 2 is a block circuit diagram of another power supply for a vehicle according to the embodiment.

FIG. 3 is a block circuit diagram of a further power supply for a vehicle according to the embodiment.

FIG. 4 is a block circuit diagram of a power-supply stabilizer according to the embodiment.

FIG. 5 is a block circuit diagram of another power-supply stabilizer according to the embodiment.

FIG. 6 is a block circuit diagram of a further power-supply stabilizer according to the present invention.

FIG. 7 is a block circuit diagram of a still further power-supply stabilizer according to the embodiment.

FIG. 8A illustrates the waveform of a current flowing in the power supply according to the embodiment.

FIG. 8B illustrates the waveform of a current flowing in the power supply according to the embodiment.

FIG. 8C illustrates the waveform of a current in the power supply according to the embodiment.

FIG. 9 is a block circuit diagram of a still further power-supply stabilizer according to the embodiment.

FIG. 10 is a schematic view of a vehicle according to the embodiment.

### REFERENCE NUMERALS

1 Power-Supply Stabilizer
2 Bidirectional DC/DC Converter
3 Storage Element
5 Voltage Detector (First Voltage Detector)
6 Voltage Detector (Second Voltage Detector)
7A Terminal (First Terminal)
7B Terminal (Second Terminal)
8 Regulator
10 Battery
11 Starter
12 Alternator
13 Rectifier
14 Electrical Load
14A Supply Port of Electrical Load (First Port)
14B Supply Port of Electrical Load (Second Port)
15 Rectifier
16 Switch
21 Switching Element (Second Switching Element)
22 Switching Element (First Switching Element)
23 Inductance Element
25 Controller
101 Engine Mechanism
5001 Vehicle
5001A Engine Room
5001B Passenger Room (Room)
5001C Trunk Room (Room)
1202A Unidirectional DC/DC Converter (First Unidirectional DC/DC Converter)
1202B Unidirectional DC/DC Converter (Second Unidirectional DC/DC Converter)

### DETAIL DESCRIPTION OF THE PREFERRED EMBODIMENT

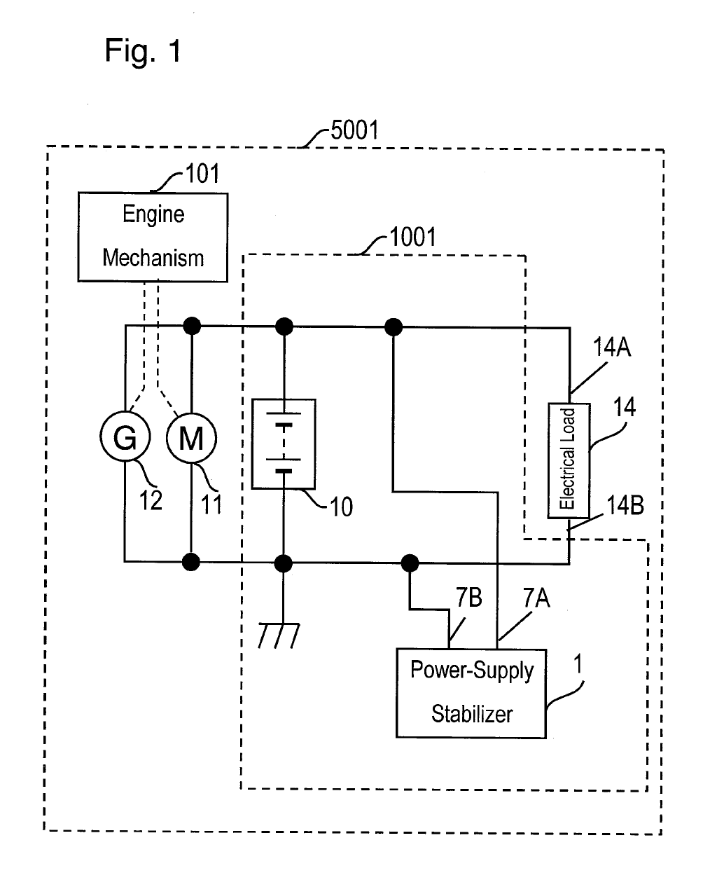

FIG. 1 is a block circuit diagram of a power supply 1001 for a vehicle according to an exemplary embodiment of the present invention. A power-supply stabilizer 1 installed in a vehicle 5001 includes a DC/DC converter and a storage element. A battery 10 may often be a lead battery having a rated voltage of 12 V. A starter 11 is connected to an engine mechanism 101. The engine mechanism 101 includes an engine and a transmission for driving the vehicle. An alternator 12 is connected to the engine mechanism 101. The vehicle 5001 includes an electrical load 14, such as an assisting device and an accessory device, connected in parallel with the power-supply stabilizer 1. The power-supply stabilizer 1 has terminals 7A and 7B. The electrical load 14 has ports 14A and 14B and operates with a power applied between ports 14A and 14B. The terminals 7A and 7B of the power-supply stabilizer 1 are connected to ports 14A and 14B of the electrical load 14, respectively.

An operation of the power supply 1001 will be explained below.

When the battery 10 supplies a power to the starter 11 by an operation to a start key, the starter 11 starts the engine of the engine mechanism 101. As the engine starts, the alternator 12 generate a power which charges the battery 10 and which is supplied to the electrical load 14.

In the case that the vehicle 5001 has an idling-stop function, the engine stops when the vehicle 5001 stops and a predetermined condition is satisfied. When a driver steps on an acceleration pedal from on a brake pedal, the starter 11 operates to start the engine. At this moment, a large current flows to the starter 11 and causes the voltage of the battery 10 to drop. Since the battery 10 is connected to the electrical load 14 for supplying the power, the voltage of the battery may drop to lower than an operating voltage of the electrical load 14, and prevent the electrical load 14 from operating properly.

The power-supply stabilizer 1 includes a bidirectional DC/DC converter charging the storage element when the alternator 12 generates the power and when the voltage of the battery 10 is normal. In the case that the voltage of the battery 10 drops due to the starting of the engine after the stopping of the engine, the storage element is discharged by the bidirectional DC/DC converter in order to energize the electrical load 14 so as to stabilize the voltage at the battery 10.

As being connected in parallel with the electrical load 14, the power-supply stabilizer 1 produces no resistance on the power supply line between the battery 10 and the electrical load 14. Accordingly, the battery 10 supplied the power to the electrical load 14 without a voltage drop, thus not requiring a switch or a bypass relay for bypassing the power-supply stabilizer 1.

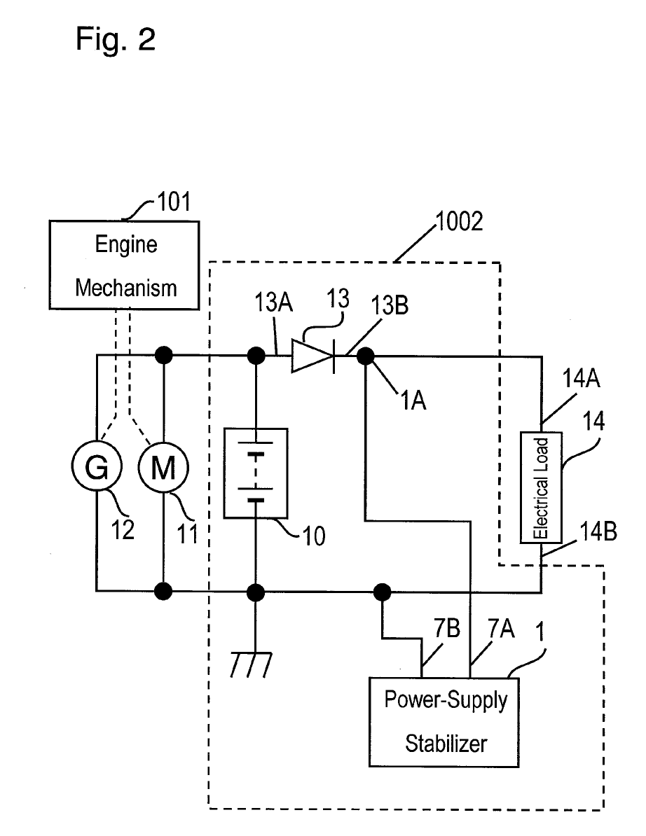

FIG. 2 is a block circuit diagram of another power supply 1002 for a vehicle according to the embodiment. In FIG. 2, components identical to those of the power supply 1001 shown in FIG. 1 will be denoted by the same reference numerals, and their description will be omitted. The power supply 1002 shown in FIG. 2, differently from that shown in FIG. 1, includes a rectifier 13 connected between the battery 10 and the electrical load 14. The power-supply stabilizer 1 is connected in parallel with the electrical load 14. The rectifier 13 has an anode 13A connected to the battery 10 and has a cathode 13B connected to a node 1A at which the electrical load 14 is connected with the power-supply stabilizer 1. When the voltage of the battery 10 drops due to the starting of the starter 11, the rectifier 13 prevents a current from flowing the power-supply stabilizer 1 to the battery 10, and allows the power-supply stabilizer 1 to supply a power to only the electrical load 14. This operation allows the power-supply stabilizer 1 to output a small power for compensating only the power to supply the electrical load 14, accordingly reducing the sizes and the weights of the DC/DC converter and the storage element.

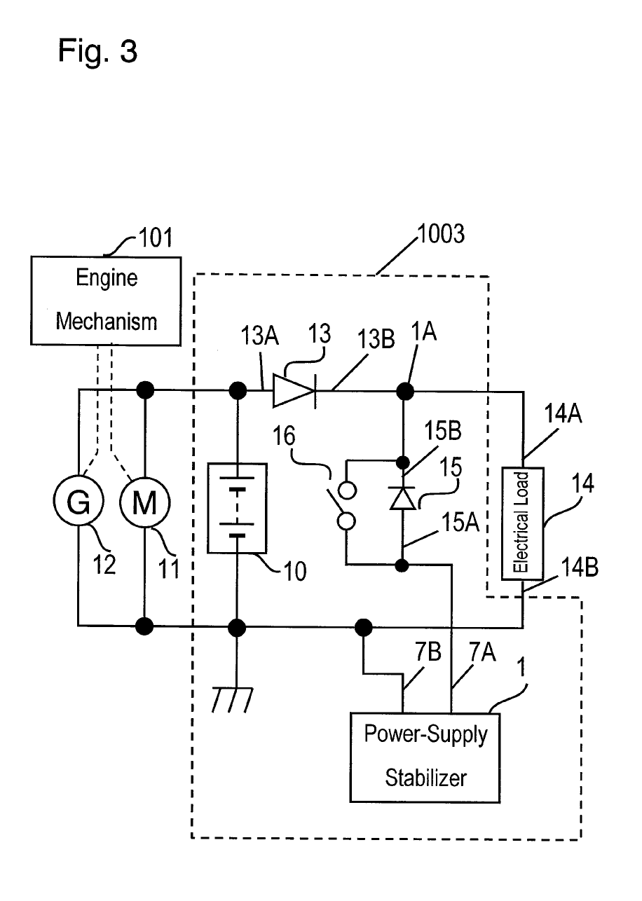

FIG. 3 is a block circuit diagram of a further power supply 1003 for a vehicle according to the embodiment. In FIG. 3, components identical to those of the power supply 1002 shown in FIG. 2 will be denoted by the same reference numerals, and their description will be omitted. The power supply 1003 shown in FIG. 3, differently from the power supply 1002 shown in FIG. 2, includes a rectifier 15 connected between the power-supply stabilizer 1 and the electrical load 14, i.e., between the power-supply stabilizer 1 and the node 1A, and includes a switch 16 connected in parallel with the rectifier 15. The rectifier 15 has a cathode 15B connected to the electrical load 14 and has an anode 15A connected to the power-supply stabilizer 1. The switch 16 is controlled to be closed at least when the storage element 3 of the power-supply stabilizer 1 is charged. The switch 16 is opened before the starter 11 is turned on, so that the DC/DC converter can start operating to discharge the storage element 3 of the power-supply stabilizer 1 before the starter 11 starts. This operation allows the power-supply stabilizer 1 to respond fast to an abrupt drop of the voltage of the battery 10 when the starter 11 is turned on, and prevents the voltage from dropping abruptly. If the rectifier 15 and the switch 16 are not connected, the bidirectional DC/DC converter used as a DC/DC converter may charge the storage element when the voltage of the battery 10 is higher than a voltage output from the power-supply stabilizer 1 during the discharging of the storage element. When the storage element is charged with a voltage close to its rated voltage, a voltage higher than the rated voltage may be applied to the storage element. The rectifier 15 and the switch 16 prevent the storage element from being charged by the bidirectional DC/DC converter when the voltage of the battery 10 is higher than the voltage output from the power-supply stabilizer 1, hence allowing the storage element to be charged with a voltage close to the rated voltage. The switch 16 is connected in parallel with the rectifier 15. The DC/DC converter may include a field effect transistor (FET) including a diode therein to eliminate the diode 15. The switch 16 is opened to reduce a standby current flowing in the power-supply stabilizer 1.

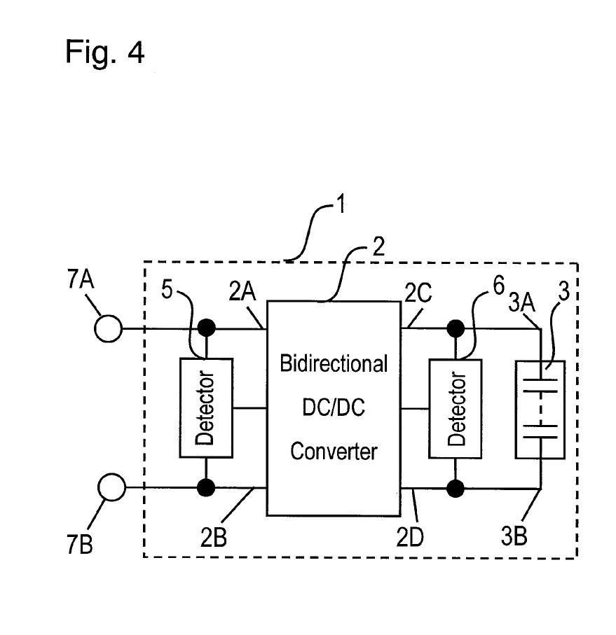

FIG. 4 is a block circuit diagram of the power-supply stabilizer 1. The power-supply stabilizer 1 includes the bidirectional converter 2, the storage element 3, voltage detectors 5 and 6, and the terminals 7A and 7B. The DC/DC converter 2 has ports 2A and 2B connected to the terminals 7A and 7B, respectively, and has ports 2C and 2D connected to the ports 3A and 3B of the storage element 3 respectively. The voltage detector 6 detects the voltage between the ports 3A and 3B of the storage element 3, i.e., between the ports 2C and 2D of the DC/DC converter 2.

When the engine of the engine mechanism 101 drives the alternator 12 to generate a power, or when the voltage of the battery 10 is normal, the bidirectional DC/DC converter 2 charges the storage element 3. The voltage detector 6 detects the voltage between the ports 3A and 3B of the storage element 3. The DC/DC converter 2 charges the storage element 3 as to control the voltage between the ports 3A and 3B to be a predetermined voltage based on the detected voltage. After the storage element 3 is charged to have the voltage between the ports 3A and 3B be identical to the predetermined voltage, the voltage detector 5 detects the voltage between the terminals 7A and 7B. The bidirectional DC/DC converter 2 outputs a power from the terminals 7A and 7B so that the voltage between the terminals 7A and 7B becomes a predetermined voltage. Thus, the voltage stabilizer 1 permits the voltage detectors 5 and 6 to be easily switched from one to the other. The bidirectional DC/DC converter 2 charges and discharges the storage element 3, allowing the power supply 1001 to have a small size and a small weight.

The charging and discharging of the storage element 3 executed by the bidirectional DC/DC converter 2 can be switched by a signal from outside. In order to avoid an abrupt pausing or erratic operation of the electrical load 14 due to a drop of the voltage of the battery 10 when the starter 11 is turned on in the vehicle having the idling-stop function, the storage element 3 is charged by the bidirectional DC/DC converter 2 while the alternator 12 works normally or while the voltage of the battery 10 is normal. After the storage element 3 is charged for storing a predetermined electric charge as to provide a predetermined voltage between the ports 3A and 3B, the power-supply stabilizer 1 outputs a signal indicating a standby status to an electronic control unit (ECU). When stopping the idling, the ECU outputs a signal to the power-supply stabilizer 1. Upon receiving the signal, the power-supply stabilizer 1 selectively turns on the voltage detector 5 for monitoring the voltage between the terminals 7A and 7B in order to prevent the voltage of the battery 10 from dropping.

When the DC/DC converter 2 operates continuously, its operational loss is critical. The DC/DC converter 2 may be stopped to save energy. However, it takes a considerable period of time for starting the DC/DC converter 2, accordingly being prevented from responding to an abrupt drop of the voltage of the battery 10. When the drop of the voltage of the battery 10 is expected, e.g. when the starting of the engine after the idling is stopped, the ECU may output a start signal before the engine starts and after the DC/DC converter 2 is stopped. This operation starts the DC/DC converter 2 previously and allows the DC/DC converter 2 to respond fast, and allows the DC/DC converter 2 to stop during an unnecessary period of time, hence reducing power consumption.

The voltage detected by the voltage detector 5 is determined to be a first value lower than a value of the voltage of the battery 10 which is in normal status. This arrangement allows the storage element 3 to supply a power via the bidirectional DC/DC converter 2 only when the voltage of the battery 10 drops, thereby preventing the voltage of the battery 10 from dropping. In this case, the voltage detected by the voltage detector 5 may be modified according to the electrical charge stored in the storage element 3. That is, if the storage element 3 stores a sufficient amount of the electric charge, the predetermined voltage to be detected by the voltage detector 5 may be determined to be closer to a rated voltage of the battery 10. If the predetermined voltage is closer to the rated voltage of the battery 10, the voltage between the terminals 7A and 7B often drops to the predetermined voltage, hence allowing the power-supply stabilizer 1 to operate frequently. If the storage element 3 stores a smaller amount of the electric charge, the voltage to be detected is determined to be a value lower than the first value. If the predetermined voltage is lower, the voltage between the terminals 7A and 7B drops to the predetermined voltage less frequently, accordingly allowing the power-supply stabilizer 1 to operate less frequently.

The storage element 3 may employ a secondary battery, such as a nickel hydrogen battery or a lithium ion battery, a lead battery, or a capacitor, which is rechargeable, and may preferably employ an electric double layer capacitor. The electric double layer capacitor has a lot of cycles to be charged and discharged repetitively, and output electricity instantly. The charging status of the electric double layer capacitor can be observed easily by monitoring the voltage of the capacitor, hence being judged, based on the voltage detected by the voltage detector 6, whether or not the power-supply stabilizer 1 is at the standby status.

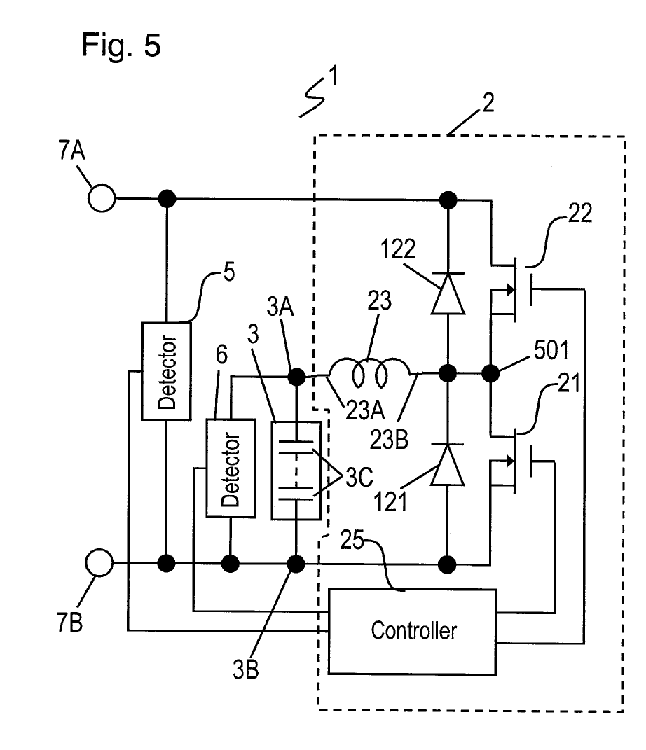

FIG. 5 is a block circuit diagram of a power-supply stabilizer 1. The bidirectional DC/DC converter 2 is a DC/DC step-down converter of synchronous rectification type. In the DC/DC converter 2, a switching element 22 connected to the terminal 7A is connected by bridge connection with a switching element 21 connected to the terminal 7B. The switching element 21 and the terminal 7B are connected at a node 501 with the switching element 22. The storage element 3 is connected in series with an inductance element 23. The storage element 3 and the inductance element 23 are connected in parallel with the switching element 21, that is, are connected between the terminal 7A and the node 501. The switching element 22 is connected between the terminal 7A and the node 501. The switching element 21 is connected between the terminal 7B and the node 501. The inductance element 23 has an end 23B connected to the node 501 and has an end 23A connected to the storage element 3.

A controller 25 controls periods during which the switching elements 21 and 22 are turned on and off in response to the voltages detected by the voltage detectors 5 and 6. More particularly, while charging the storage element 3, the controller 25 controls the voltage between the ports 3A and 3B according to the voltage detected by the voltage detector 6. while discharging the storage element 3, the controller 25 controls the voltage between the terminals 7A and 7B according to the voltage detected by the voltage detector 5.

The bidirectional DC/DC converter 2 shown in FIG. 5 is the step-down type DC/DC converter, and charges the storage element 3 with a voltage lower than the voltage of the battery 10. The storage element 3 may include plural electric double layer capacitors 3C connected in series. In the case that the storage element 3 includes elements, such as the electric double layer capacitors 3C, having low electric strength, the DC/DC converter 2 reduces the number of the elements, accordingly reducing the volume and weight of the power-supply stabilizer 1. As the storage element 3 is discharged for compensating the voltage drop in the battery 10, the voltage between both ends of each of the electric double layer capacitors 3C decreases. However, the DC/DC converter 2 stabilizes the voltage between the terminals 7A and 7B, accordingly stabilizing the voltage of the battery 10.

Diodes 121 and 122 connected in parallel with the switching elements 21 and 22, respectively, are turned on when the switching elements 21 and 22 delay to turn on, thereby reducing a switching loss of the switching elements 21 and 22. Each of the switching elements 21 and 22 may employ a field effective transistor (FET) having a diode, hence eliminating the diodes 121 and 122.

The number of the electric double layer capacitors 3C used as the storage element 3 ranges preferably from two to four, and increases the operational efficiency of the DC/DC converter 2. If the voltage of the battery is applied directly to the storage element, six or seven electric double layer capacitors are necessary. In comparison, the number of the double layer capacitors 3C of the power-supply stabilizer 1 is almost half.

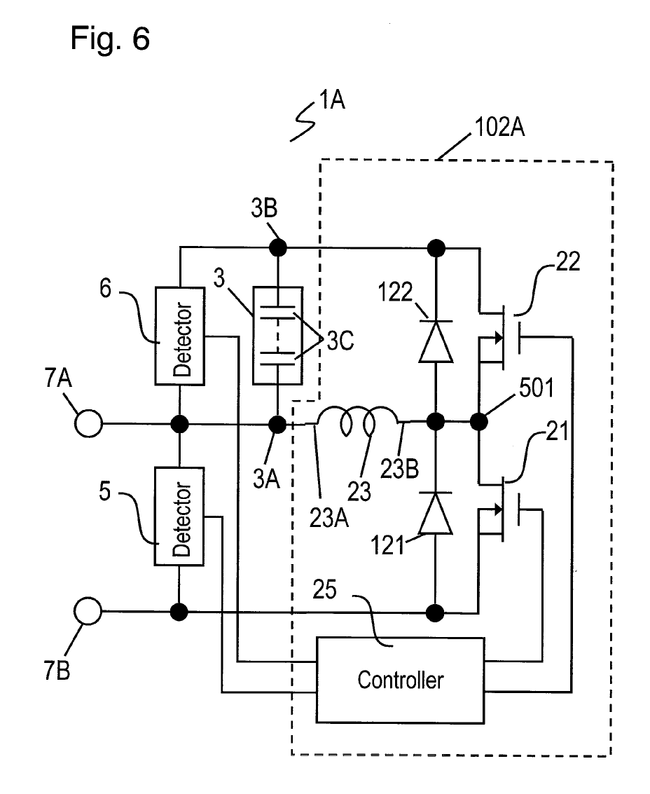

FIG. 6 is a block circuit diagram of another power-supply stabilizer 1A according to the embodiment. The power-supply stabilizer 1A includes a bidirectional DC/DC converter 102A in stead of the bidirectional DC/DC converter 2 of the power-supply stabilizer 1 shown in FIG. 5. The bidirectional DC/DC converter 102A is a DC/DC converter of synchronous rectification inverted polarity type. In FIG. 6, components identical to those shown in FIG. 5 will be denoted by the same reference numerals, and their description will be omitted. In the power-supply stabilizer 1A, the inductance element 23 and the switching element 21 are coupled in series with each other and connected between the terminals 7A and 7B. More specifically, the inductance element 23 has the end 23A connected to the terminal 7A and ash the end 23B connected to the node 501. The switching element 22 and the storage element 3 are coupled in series with each other and connected in parallel with the inductance element 23. More specifically, the storage element 3 has an end 3A connected to the end 23A of the inductance element 23, i.e., to the terminal 7A. The switching element 22 is connected between the end 3B of the storage element 3 and the node 501. The switching element 21 is connected between the node 501 and the terminal 7B. The end 23B of the inductance element 23 is connected to the node 501, and the end 23A is connected to the end 3A of the storage element 3.

In the power-supply stabilizer 1A, a voltage between the ports 3A and 3B of the storage element 3 is added to a voltage between the terminals 7A and 7B, i.e., to the voltage of the battery 10, thus allowing the switching elements 21 and 22 to generate a voltage higher than the voltage of the battery 10. If the vehicle 5001 requires a voltage higher than the voltage of the battery 10, the DC/DC converter 102A can supply the higher voltage. The power-supply stabilizer 1A will thus be improved in the performance.

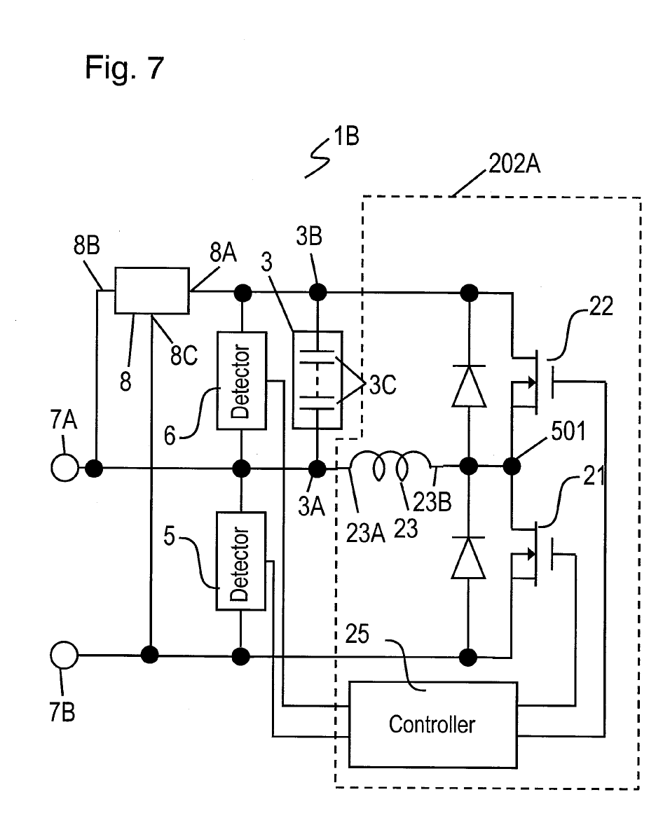

FIG. 7 is a block circuit diagram of a further power-supply stabilizer 1B according to the embodiment. The power-supply stabilizer 1B includes a bidirectional DC/DC converter 202A instead of the bidirectional DC/DC converter 2 of the power-supply stabilizer 1 shown in FIG. 5. In FIG. 7, components identical to those shown in FIG. 6 will be denoted by the same reference numerals, and their description will be omitted. The power-supply stabilizer 1B shown in FIG. 7 includes a regulator 8 connected with the port 3B of the storage element 3 and the terminals 7A and 7B. The regulator 8 has an input port 8A, an output port 8B, and a common port 8C. The regulator 8 receives a voltage between the input port 8A and the common port 8C, and outputs a stabilized voltage between the output port 8B and the common port 8C.

When the voltage of the battery 10 abruptly drops, the bidirectional DC/DC converter 202A discharges the storage element 3 as to carry the stored power to the terminals 7A and 7B for preventing the voltage of the battery 10 from dropping. The voltage of the battery 10 may drop instantaneously if a response speed of the DC/DC converter 202A is lower than the speed of the dropping of the voltage of the battery 10. In order to avoid the instantaneous voltage drop, the power-supply stabilizer 1B includes the regulator 8 having a response speed higher than that of the DC/DC converter 202A. When the DC/DC converter 202A does not operate properly soon after the drop of the voltage drop of the battery 10, i.e., the drop of a voltage between the terminals 7A and 7B, a sum of the voltage of the storage element 3 and the voltage between the terminals 7A and 7B is applied between the input port 8A and the common port 8C of the regulator 8. The regulator 8, in response, supplies a voltage sufficiently activating the electrical lord (FIG. 1) from between the output port 8B and the common port 8C. That is, while the regulator 8 requires a voltage higher than the voltage of the battery 10 in order to supply a power to the terminals 7A and 7B, the higher voltage is produced by the power-supply stabilizer 1B adding the voltage from the storage element 3 to the voltage between the terminals 7A and 7B.

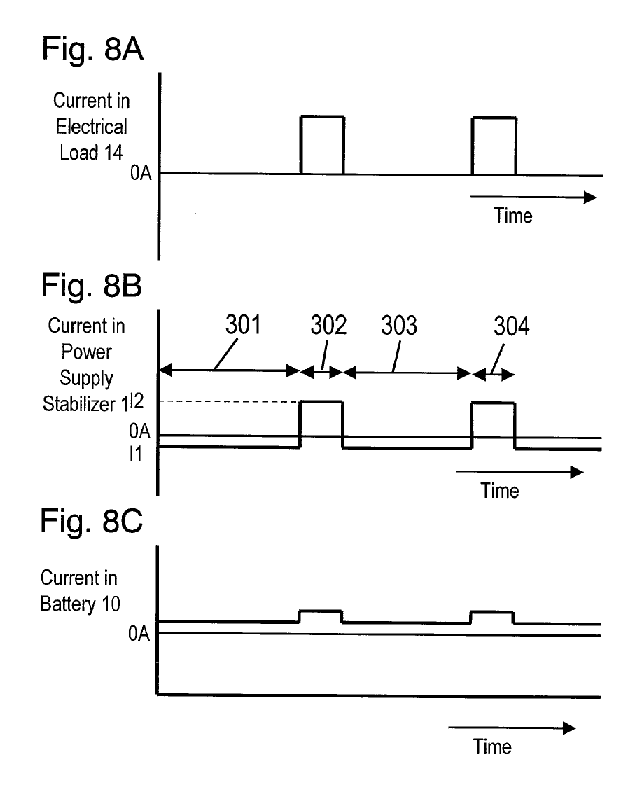

FIGS. 8A to 8C illustrate profiles of respective currents flowing in the electrical load 14, the power-supply stabilizer 1, and the battery 10 of the power supply 1001 for a vehicle. When the current shown in FIG. 8A flows in the electrical load 14, the power-supply stabilizer 1 and the battery 10 supply the currents shown in FIGS. 8B and 8C to the electrical load 14, respectively, although their rate may vary according to the resistances of harness wires connected to the electrical load 14. As shown, the power-supply stabilizer 1 reduces the current from the battery 10. As shown in FIG. 8B, in the power-supply stabilizer 1, the storage element 3 is charged for the periods 301 and 303 and discharged for the periods 302 and 304. Since a charging current 11 flowing to the storage element 3 is smaller than a discharging current 12 from the storage element 3, a peak of the current from the battery 10 is reduced, accordingly reducing a load on the battery 10. Also, the power-supply stabilizer 1 averages a pulse waveform of the current flowing in the electrical load 14, as shown in FIG. 8A, and reduces an effective value of the current, accordingly reducing a loss due to the resistance of the harness wires. This can be achieved by differentiating a limit of a current charging the storage element 3 of the bidirectional converter 2 from a limit of a current discharging the storage element 3.

The power-supply stabilizer 1 (1A, 1B) according to the embodiment is connected in parallel with the electrical load 14, and can supply, to the electrical load 14, a voltage of the battery 10 without drop the voltage when the voltage of the battery 10 is normal.

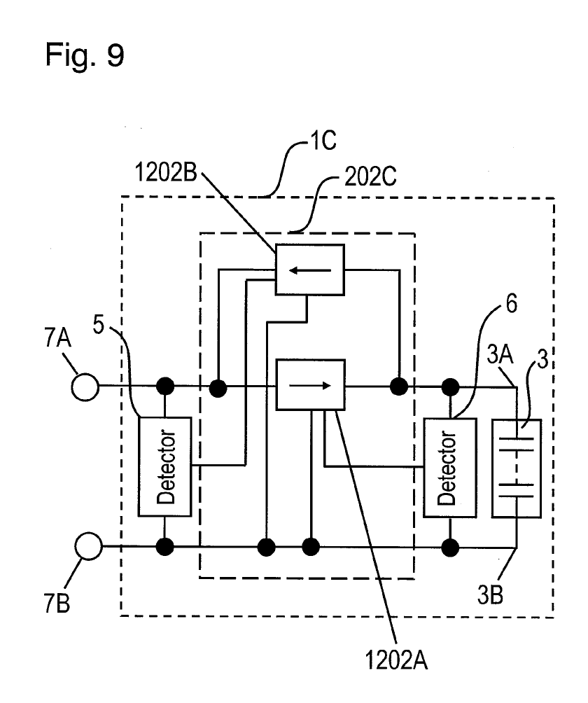

FIG. 9 is a block circuit diagram of a still further power-supply stabilizer 1C of the power supply for a vehicle according to the embodiment. In FIG. 9, components identical to those shown in FIG. 4 will be denoted by the same reference numerals, and their description will be omitted. The power-supply stabilizer 1C shown in FIG. 9 includes a bidirectional DC/DC converter 202C instead of the bidirectional DC/DC converter 2 shown in FIG. 4. The bidirectional DC/DC converter 202C consists of two unidirectional DC/DC converters 1202A and 1202B. The unidirectional DC/DC converter 1202A charges the storage element 3 with the voltage between the terminals 7A and 7B. The unidirectional DC/DC converter 1202B receives the voltage discharged from the storage element 3, and outputs the received voltage between the terminals 7A and 7B. The bidirectional DC/DC converter 202C provides the same effects as those of the bidirectional DC/DC converter 2 shown in FIG. 4. The power-supply stabilizer 1C includes the two unidirectional DC/DC converters 1202A and 1202B, thus having a large number of components. The limit of the current of the unidirectional DC/DC converter 1201A for charging the storage element 3 may be smaller than the limit of the current of the unidirectional DC/DC converter 1201B for discharging the storage element 3, thereby performing the averaging the currents shown in FIGS. 8A to 8C. The limit of the current of the unidirectional DC/DC converter 1202A for charging the storage element 3 is small, hence allowing the unidirectional DC/DC converter 1202A to have a small size. The control of only the unidirectional DC/DC converter 1202B out of the two unidirectional DC/DC converters 1202A and 1202B prevents the voltage between the terminals 7A and 7B from dropping without the switching of the bidirectional DC/DC converter 2.

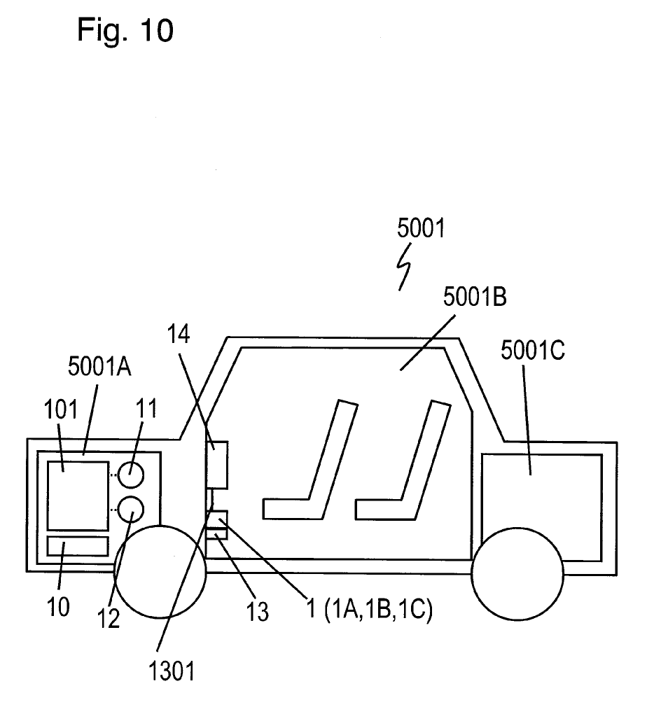

FIG. 10 is a schematic view of the vehicle 5001 according to the embodiment. The vehicle 5001 includes an engine room 5001A, a passenger room 5001B, and a trunk room 5001C. The engine room 5001A accommodates therein the engine mechanism 101 including the engine. The passenger room 5001B is a room different from the engine room 5001A. The trunk room 5001C is a room different from the engine room 5001A. The engine room 5001A further accommodates the alternator 12 connected with the engine mechanism 101, the battery 10 charged by the alternator 12, and the starter 11 connected with the battery 10. The vehicle 5001 includes the electrical load 14 connected with the battery 10, the rectifier 13 connected between the battery 10 and the electrical load 14, and the power-supply stabilizer 1 (1A, 1B, 1C) connected in parallel with the electrical load 14.

The power-supply stabilizer 1 includes the storage element 3 and the DC/DC converter 2, and is mounted at a desired location between the battery 10 and the electrical load 14. The power-supply stabilizer 1 is connected via a harness wire 1301 to the electrical load 14. Since the voltage supplied from the battery 10 varies according to the resistance of the harness wire 1301, the power-supply stabilizer 1 is preferably located adjacent to the battery 10 and an electrical load out of the electrical load 14. The electrical load 14 having a large power consumption may include auxiliary devices, such as an electric power steering, power windows, and power sheets, and accessories, such as an audio set and a navigation system. The electrical load 14 is usually located in the passenger room 5001B rather than in the engine room 5001A. Accordingly, the power-supply stabilizer 1 may be mounted preferably in either the passenger room 5001B or the trunk room 5001C. Thus, the power-supply stabilizer 1 can be mounted at a desired location in the vehicle 5001 according to the location of the electrical load 14.

The storage element 3 may employ a secondary battery, a lead battery, or a capacitor. These devices have not so high rated temperatures. The storage element 3 is located in either the passenger room 5001B or the trunk room 5001C which has a temperature lower than that of the engine room 5001A heated by the engine mechanism 101, thereby increasing reliability of the storage element 3.

The power-supply stabilizer 1 is located near the electrical load 14 having a large power consumption, thereby being prevented from affecting other electrical loads.

The vehicle 5001 may include plural power-supply stabilizers 1. This arrangement further stabilizes the voltage of the power supply.

The power-supply stabilizer 1 (1A, 1B, 1C) is connected in parallel with the electrical load 14, consequently eliminating relays and switches for bypassing the power-supply stabilizer 1. This arrangement allows the power supply 1001 (the power-supply stabilizer) 1 to be located in either the passenger room 5001B or the trunk room 5001C but not in the engine room 5001A close to the battery 10. Hence, the power supply 1001 can be mounted in a vehicle including the engine room 5001A having a small size and including the passenger room 5001B and the trunk room 5001C having large sizes.

### INDUSTRIAL APPLICABILITY

A power supply for a vehicle according to the present invention stabilizes a voltage supplied from a battery and can is applicable to a power supply in particularly a hybrid vehicle and a vehicle having an idling-stop function.

1. A power-supply stabilizer arranged to be used in a vehicle which includes an alternator connected with an engine mechanism, a battery charged by the alternator, a starter connected with the battery, and an electrical load having a first end and a second end connected with the battery, said power-supply stabilizer comprising:
a storage element;
a first terminal connected between the battery and the first end of the electrical load;
a second terminal connected between the battery and the second end of the electrical load; and
a bidirectional DC/DC converter coupled to the battery, the bidirectional DC/DC converter being connected between the first terminal and the second terminal, the bidirectional DC/DC converter charging and discharging the storage element,
wherein the power-supply stabilizer is arranged to be connected in parallel with the electrical load.

2. The power-supply stabilizer according to claim 1, further comprising a rectifier connected between the battery and the first terminal.

3. The power-supply stabilizer according to claim 1, further comprising:
a rectifier connected between the first terminal and the bidirectional DC/DC converter; and
a switch connected in parallel with the rectifier.

4. The power-supply stabilizer according to claim 3, wherein the rectifier has a cathode connected with the first terminal and has an anode connected with the bidirectional DC/DC converter.

5. The power-supply stabilizer according to claim 3, wherein the switch is turned on at least while the storage element is charged, and is turned off at least while the storage element is discharged.

6. The power-supply stabilizer according to claim 3, wherein the switch is turned off before the starter starts.

7. The power-supply stabilizer according to claim 1, wherein the bidirectional DC/DC converter operates to discharge the storage element before the starter starts.

8. The power-supply stabilizer according to claim 1, further comprising:
a first voltage detector for detecting a voltage between the first terminal and the second terminal; and
a second voltage detector for detecting a voltage of the storage element,
wherein the bidirectional DC/DC converter includes a controller for controlling the voltage between the first terminal and the second terminal in response to the voltage detected by the first voltage detector and of the voltage detected by the second voltage detector.

9. The power-supply stabilizer according to claim 8, wherein the controller allows the first voltage detector to detect the voltage between the first terminal and the second terminal when the second voltage detector detects a predetermined voltage.

10. The power-supply stabilizer according to claim 8, wherein the controller switches, based on an external input signal, between that the first voltage detector detects the voltage between the terminals and that the second voltage detector detects the voltage of the storage element.

11. The power-supply stabilizer according to claim 1, wherein the storage element comprises an electric double layer capacitor.

12. The power-supply stabilizer according to claim 11, wherein a voltage for charging the storage element is lower than a voltage of the battery.

13. The power-supply stabilizer according to claim 1, wherein the bidirectional DC/DC converter includes
a first switching element connected between the first terminal and a node,
a second switching element connected between the node and the second terminal, and
an inductance element having a first end connected to the node and has a second end connected to the storage element.

14. The power-supply stabilizer according to claim 1, wherein
the storage element has a first end and a second end thereof connected to the bidirectional DC/DC converter, and
the bidirectional DC/DC converter includes
a first switching element connected between the second end of the storage element and a node,
a second switching element connected between the node and the second terminal, and
an inductance element having a first end connected to the node and has a second end connected to the first end of the storage element.

15. The power-supply stabilizer according to claim 1, further comprising a regulator having an input port, an output port, and a common port, the input port being connected to the second end of the storage element, the output port being connected to the first terminal, the regulator stabilizing a voltage applied between the input port and the common port and outputting the stabilized voltage from between the output port and the common port.

16. The power-supply stabilizer according to claim 1, wherein a current for charging the storage element is lower than a current for discharging the storage element.

17. The power-supply stabilizer according to claim 1, wherein the bidirectional DC/DC converter includes
a first unidirectional DC/DC converter for charging the storage element, and
a second unidirectional DC/DC converter for discharging the storage element.

18. A vehicle comprising:
an engine mechanism;
an alternator connected with the engine mechanism;
a battery charged by the alternator;
a starter connected with the battery;
an electrical load connected with the battery; and
a power-supply stabilizer connected in parallel with the electrical load, the power-supply stabilizer including
a storage element;
a first terminal connected between the battery and the electrical load,
a second terminal connected with the battery and the electrical load, and
a bidirectional DC/DC converter coupled to the battery and connected to the first terminal and the second terminal, the bidirectional DC/DC converter charging and discharging the storage element,
wherein the power-supply stabilizer is connected in parallel with the electrical load.

19. The vehicle according to claim 18, further comprising:
an engine room accommodating the engine mechanism therein; and
a room accommodating the electrical load and the power-supply stabilizer, the room being different from the engine room.

20. The vehicle according to claim 18, wherein the engine room accommodates the engine mechanism, the alternator, the battery, and the starter.

21. The vehicle according to claim 18, wherein the power-supply stabilizer is located closer to the electrical load than to the battery.

22. The vehicle according to claim 18, wherein the power-supply stabilizer further includes
a rectifier connected between the first terminal and the bidirectional DC/DC converter, and
a switch connected in parallel with the rectifier.

23. The vehicle according to claim 22, wherein the rectifier has a cathode connected to the first terminal and has an anode connected to the bidirectional DC/DC converter.
